(19) United States
(12) Patent Application Publication
(10) Pub. No.: US 2010/0014860 A1
(43) Pub. Date: Jan. 21, 2010

(54) COMMUNICATION APPARATUS AND COMMUNICATION METHOD

(75) Inventor: Toshiyuki Nakagawa, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/502,106

(22) Filed: Jul. 13, 2009

(30) Foreign Application Priority Data
Jul. 17, 2008 (JP) 2008-186243

(51) Int. Cl. H04J 14/00; H04N 7/173

(52) U.S. Cl. 398/66; 725/118

(57) ABSTRACT

A communication apparatus configured to transmit moving image data to a receiving apparatus via a network. The communication apparatus includes a coding unit configured to code the moving image data, a control information generation unit configured to determine a degree of importance of each packet of the moving image data coded by the coding unit and transmission quality of the network, and generate, for each packet, control information to control communication service quality according to the determined degree of importance and transmission quality, a packet generation unit configured to generate a packet based on the moving image data coded by the coding unit and the control information generated by the control information generation unit, and a communication control unit configured to transmit the packet generated by the packet generation unit.

### BACKGROUND OF THE INVENTION

1. Field of the Invention

The present invention relates to a communication apparatus and a communication method, and more particularly to transmission technology to transmit moving image data via a network.

2. Description of the Related Art

With diffusion of Asymmetric Digital Subscriber Line (ADSL) and Fiber to the home (FTTH) services, broadband communication has become prevalent in a network environment including Internet. In addition, processing capacity of various computing devices, such as personal computers (PC) is remarkably improved.

Because of performance improvement in the communication environment and a data processing environment, streaming technology for distributing multimedia data, such as moving images and sound in real time via the network has come into practical use. Along with practical use of the streaming technology, users can watch and listen to broadband broadcasting of live media or recorded media and recorded media on demand.

For services in which a delay or an interruption of communication is not tolerated, such as real-time distribution of moving images and sound or a television telephone, a quality of service (QoS) technique is important which guarantees a communication speed, delay time, a jitter amount, and a packet loss ratio.

For example, Japanese Patent Application Laid-Open No. 2005-354270 discusses a method in which an error correction coding rate or an error handling process method necessary to maintain a required communication service quality are previously stored in a table by associating with a packet transmission condition, and an error correction coding process or the error handling process is executed based on the transmission condition and the stored information in the table for each packet of a transmission target.

In Japanese Patent No. 3730977, instead of using the processing such as retransmission, error detection, and error correcting code, a method is discussed which determines a number of times of data transmission based on priority, an image frame type, and a coding system, and repeatedly transmits data and information about the number of times of data transmission.

Normally, in wireless communication, acknowledgement (Ack) indicating that a data packet has been normally received is returned in response to the transmitted data packet. Though this Ack becomes overhead, the Ack ensures robustness of communication in an environment where transfer of data may fail due to noise, for example. The Institute of Electrical and Electronics Engineers (IEEE) 802.11e as one of wireless local area network (LAN) standards or Wi-Fi multimedia (WMM) provides a QoS function that controls communication by setting an order of priority (voice, video, best effort, background) to traffic.

However, in a technique described in Japanese Patent Application Laid-Open No. 2005-354270, there is a problem that an error correction coding process or an error handling process can be executed only in terms of a protocol type or an application type. On the other hand, according to a technique described in Japanese Patent No. 3730977, since data is transmitted repeatedly up to a determined number of transmission times, even if duplicate transmission is selectively performed, redundancy of transmitted data increases and efficiency of transmission decreases.

In transmission control in the conventional wireless LAN standards, a number of times of data retransmission is limited to a fixed value which is set in wireless LAN equipment, and the transmission control is implemented according to priority for each type of data or the traffic. Therefore, consistent QoS control is performed over data in the same bit stream.

### SUMMARY OF THE INVENTION

The present invention is directed to data transmission in which communication service quality is controlled meticulously for each packet in transmission of moving image data.

According to an aspect of the present invention, a communication apparatus configured to transmit moving image data to a receiving apparatus via a network. The communication apparatus includes a coding unit configured to code the moving image data, a control information generation unit configured to determine a degree of importance of each packet of the moving image data coded by the coding unit and transmission quality of the network, and generate, for each packet, control information to control communication service quality according to the determined degree of importance and transmission quality, a packet generation unit configured to generate a packet based on the moving image data coded by the coding unit and the control information generated by the control information generation unit, and a communication control unit configured to transmit the packet generated by the packet generation unit.

According to exemplary embodiments of the present invention, data transmission can be performed by meticulously implementing communication service quality control on each packet while maintaining the communication service quality in transmission of moving image data and effectively using communication bands.

Further features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 illustrates an example of a configuration of the whole communication system according to a first exemplary embodiment of the present invention.

FIG. 2 illustrates an example of a configuration of a data transmission apparatus according to the first exemplary embodiment of the present invention.

FIG. 3 is a flowchart illustrating an example of a procedure for packet generation processing in the data transmission apparatus according to the first exemplary embodiment.

FIG. 4 illustrates an example of a table for selecting a maximum number of retransmission times.

FIG. 5 illustrates an example of settings of QoS control information.

FIG. 6 illustrates a structure of an internet protocol (IP) packet transmitted by the data transmission apparatus according to the first exemplary embodiment.

FIG. 7 illustrates an example of a configuration of an optional part of an IP packet according to the first exemplary embodiment.

FIG. 8 illustrates an example of a configuration of a first data relaying apparatus according to the first exemplary embodiment.

FIG. 9 is a flowchart illustrating an example of a procedure for packet transfer processing in the first data relaying apparatus according to the first exemplary embodiment.

FIG. 10 illustrates an example of a sequence of packet retransmission control between data relaying apparatuses according to the first exemplary embodiment.

FIG. 11 illustrates an example of a table for selecting an allowable delay time.

FIG. 12 illustrates an example of a configuration of an optional part of an IP packet according to a second exemplary embodiment of the present invention.

FIG. 13 is a flowchart illustrating an example of a procedure for packet transfer processing in the first data relaying apparatus according to the second exemplary embodiment.

FIG. 14 illustrates computer functions that can realize a communication apparatus according to the exemplary embodiments of the present invention.

FIG. 15 illustrates an example of a table for selecting transmission priority.

FIG. 16 illustrates a structure of a type of service (TOS) field of an IP packet according to a third exemplary embodiment.

### DETAILED DESCRIPTION OF THE EMBODIMENTS

Various exemplary embodiments, features, and aspects of the invention will be described in detail below with reference to the drawings.

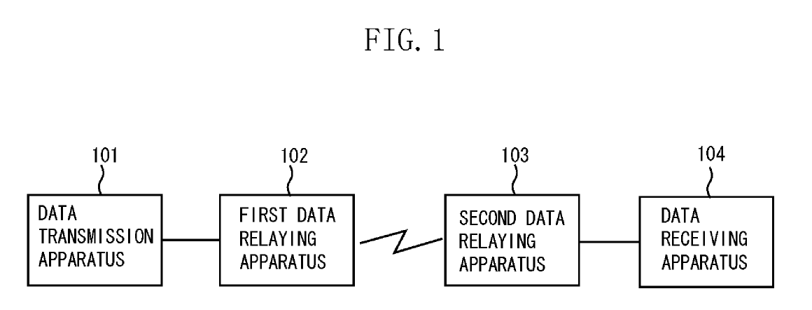

FIG. 1 is an example of a configuration of an entire communication system including a communication apparatus according to a first exemplary embodiment of the present invention.

In the communication system according to the first exemplary embodiment, in communication between a data transmission apparatus 101 and a data receiving apparatus 104, data (packet) is transmitted and received via a first data relaying apparatus 102 and a second data relaying apparatus 103. Data transmission and reception between the first data relaying apparatus 102 and the second data relaying apparatus 103 is performed by wireless communication complying with wireless communication standards, such as IEEE 802.11g. In the communication system according to the first exemplary embodiment, for example, moving image data is divided into packets and sent from the data transmission apparatus 101 to the data receiving apparatus 104.

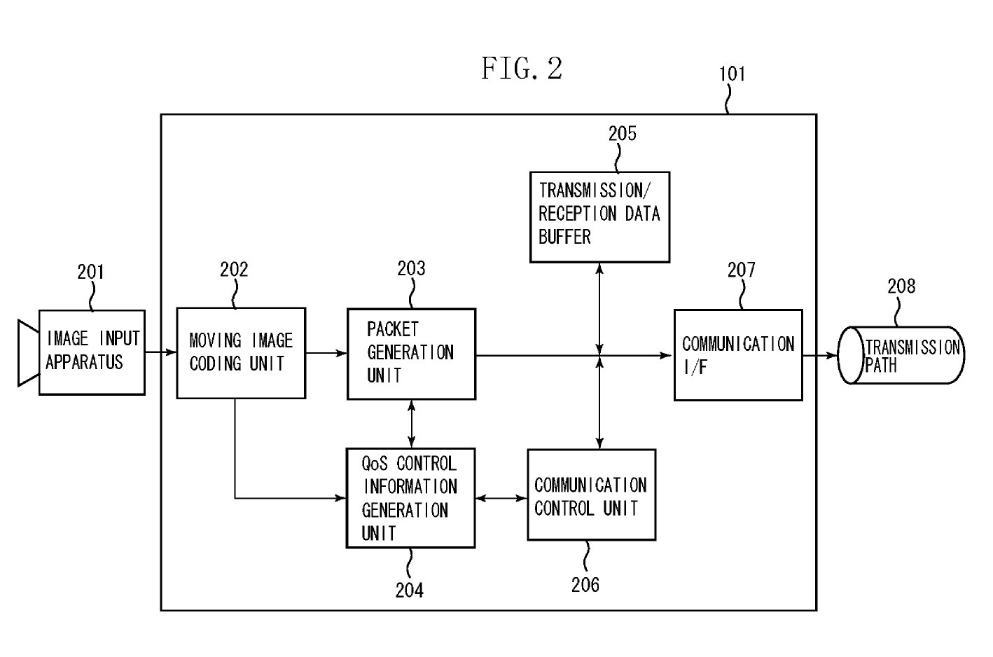

FIG. 2 is a block diagram illustrating an example of a functional configuration of the data transmission apparatus 101 according to the first exemplary embodiment. As illustrated in FIG. 2, the data transmission apparatus 101 includes a moving image coding unit 202, a packet generation unit 203, a QoS control information generation unit 204, a transmission/reception data buffer 205, a communication control unit 206, and a communication interface (I/F) 207.

The moving image coding unit 202 compresses and codes moving image data input from an image input device 201, such as a video camera or a Web camera, by a predetermined coding system, such as moving picture experts group (MPEG)-4. The moving image coding unit 202 supplies the packet generation unit 203 with coded moving image data in units of frames. The moving image coding unit 202 generates referenced macroblock information of the moving image data and supplies the information to the QoS control information generation unit 204. The referenced macroblock information indicates a number of times of reference made to a macroblock (MB) in a coding process performed on the moving image data.

The packet generation unit 203 generates packets from the coded moving image data input from the moving image coding unit 202 and control information for QoS control (communication service quality control) input from the QoS control information generation unit 204. The packets generated by the packet generation unit 203 are stored in the transmission/reception data buffer 205.

The QoS information generation unit 204 generates the control information for QoS control for each packet according to a degree of importance of each packet of the moving image data and a transmission quality of the network via which the moving image data is transmitted. The process of generating the control information for QoS control will be described below in detail. The QoS control information generation unit 204 supplies the generated control information for QoS control to the packet generation unit 203.

The transmission/reception data buffer 205 stores data which is transmitted to or received from a storage unit (not shown).

The communication control unit 206 controls data transmission and reception. For example, the communication control unit 206 controls a communication path and a protocol in data transmission. Under control of the communication control unit 206, the packets of moving image data which are generated by the packet generation unit 203 and temporarily stored in the transmission/reception data buffer 205 are transmitted from the communication interface 207.

The communication interface 207 connects the data transmission apparatus 101 to a transmission path 208 to exchange data with another apparatus communicably connected via the transmission path 208 (e.g., the first data relaying apparatus 102 in the example in FIG. 1). The various types of networks are representative of the transmission path 208. In the present exemplary embodiment, transmission and reception of packets of moving image data is performed via the transmission path 208.

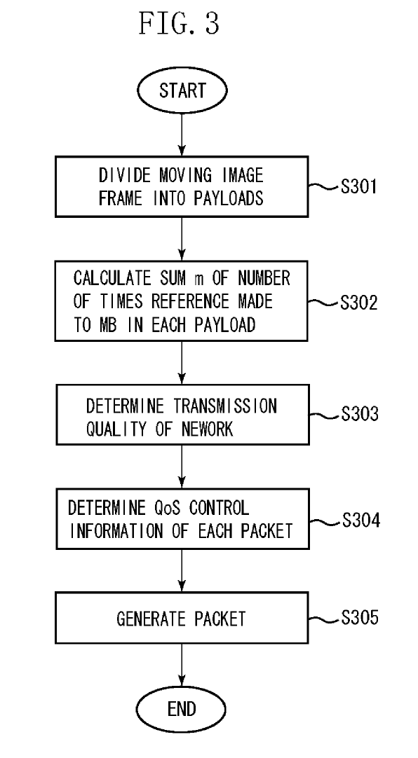

FIG. 3 is a flowchart illustrating an example of a procedure for packet generation processing in the data transmission apparatus 101 in the first exemplary embodiment.

In step S301, the packet generation unit 203 divides a frame of the moving image data input from the moving image coding unit 202 into payloads. Generally, each frame of the moving image data is divided into a plurality of payloads in units of a maximum transmission unit (MTU) size which is a maximum amount of transmittable data in one transmission on the network or units of a video packet.

In step S302, the QoS control information generation unit 204 calculates a sum m of the number of times of reference made to the macroblock included in the payloads of each packet of the moving image data. The sum m of the number of times of reference made to the macroblock is calculated from the referenced macroblock information input from the moving image coding unit 202 and configuration information of the macroblock included in the payload of each packet of the moving image data input from the packet generation unit 203. The calculated sum m of the number of times of reference made to the macroblock is used as information for determining the degree of importance of each packet of the moving image data, that is, as information indicating the degree of importance.

In step S303, the communication control unit 206 determines the transmission quality of the network via which the packets of the moving image data are transferred, and supplies a result of determination to the QoS control information generation unit 204. The communication control unit 206 determines a network error ratio, throughput, and delay time, Round Trip Time (RTT) which is required for a round trip of a packet, for example.

Subsequently, in step s304, the QoS control information generation unit 204 determines a maximum number of retransmission times for each packet in a section (a wireless section) where packets are transferred by wireless communication as the control information for QOS control of each packet (hereafter referred to as QoS control information). The QoS control information generation unit 204 determines the maximum number of retransmission times according to the sum m of the number of times of reference made to the macroblock in step S302 and the transmission quality of the network determined in step S303. The QoS control information generation unit 204 outputs a determined maximum number of retransmission times to the packet generation unit 203.

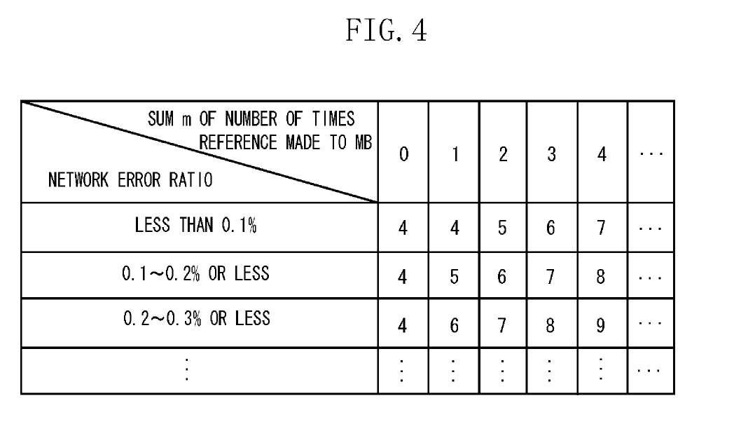

The maximum number of retransmission times in step S304 can be determined according to a table for selecting a maximum number of retransmission times in FIG. 4. FIG. 4 is an example of the table for selecting a maximum number of retransmission times. The table for selecting a maximum number of retransmission times is recorded in the QoS control information generation unit 204.

The table for selecting a maximum number of retransmission times illustrated in FIG. 4 includes the sum m of the number of times of reference made to the macroblock and the network error ratio. In other words, the table for selecting a maximum number of retransmission times in FIG. 4 stores the sum m of the number of times of reference made to the macroblock which indicates the degree of importance of each packet of the moving image data and the network error ratio which indicates the transmission quality of the network by associating with the maximum number of retransmission times which is the QoS control information. By using the table for selecting a maximum number of retransmission times, a threshold value of the maximum number of retransmission times can be determined from the values in the table.

Generally, a packet having a large sum m of the number of times of reference made to the macroblock included in the packet has a high degree of importance. Under a condition that the transmission quality of the network is the same, a maximum number of retransmission times is set larger for the packet with the large sum m of the number of times of reference made to the macroblock. Conversely, a packet with a small sum m of the number of times of reference made to the macroblock has a low degree of importance, and therefore under the condition that the transmission quality of the network is the same, the maximum number of retransmission times is set smaller for the packet with the small sum m of the number of times of reference made to the macroblock.

Even when the sum m of the number of times of reference made to the macroblock is the same, that is, when the degree of importance of the packet is the same, the maximum number of retransmission times changes according to the transmission quality of the network, and normally, the maximum number of retransmission times is set larger as the error ratio of the network becomes larger. For an application which requires real-time performance, a number of retransmission times is set smaller in the whole table for selecting a maximum number of retransmission times.

Arbitrary values can be used for an increment in the maximum number of retransmission times for an increase in the sum m of the number of times of reference made to the macroblock and for the network error ratio. For those values, optimum values may be determined based on experience by considering an overall balance.

Instep S305, the packet generation unit 203 generates a packet by recording, in the packet, payload data generated in step S301 and the maximum number of retransmission times for each packet which is generated in step S304 and input by the QoS control information generation unit 204. Then, the packet generation processing of the moving image data is completed.

By the above process, each frame of the moving image data input to the packet generation unit 203 is packetized, and stored in the transmission/reception data buffer 205. The communication control unit 206 transmits the packets of the moving image data recorded in the transmission/reception data buffer 205 to a predetermined destination.

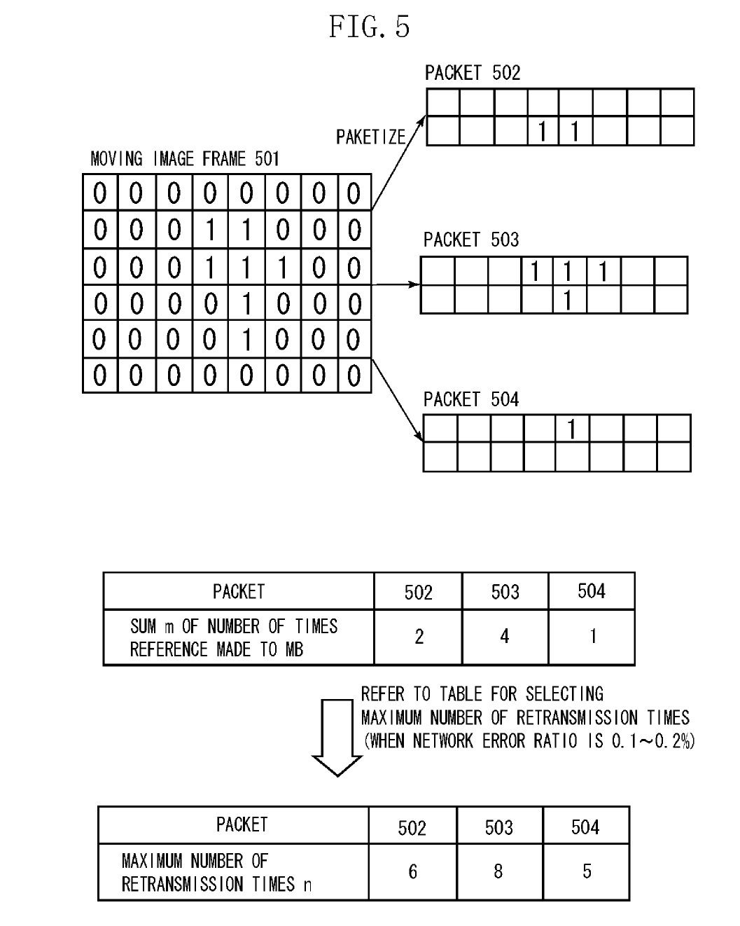

FIG. 5 illustrates an example of settings of the QoS control information in the data transmission apparatus 101.

As illustrated in FIG. 5, a frame of moving image data (moving image frame) 501 is divided into three packets 502 to 504 when it is transmitted. In the present exemplary embodiment, a number of macroblocks included in each packet 502 to 504 will be described as the same. However, in MPEG-4 system, a resynchronization marker is inserted based on a generated bit length, and therefore a packet may include different numbers of macroblocks.

As described above, the QoS control information in the present exemplary embodiment is determined according to the sum m of the number of times of reference made to the macroblock included in each packet. In FIG. 5, the sum m of the number of times of reference made to the macroblock included in each packet is 2 in the packet 502, 4 in the packet 503, and 1 in the packet 504.

Therefore, referring to the table for selecting a maximum number of retransmission times in FIG. 4, when the network error ratio is between 0.1% and 0.2%, the QoS control information is generated by setting 6 as the maximum number of retransmission times of the packet 502. Because the sum m of the number of times of reference made to the macroblock of the packet 503 is 4, the QoS control information is generated by setting 8 as the maximum number of retransmission times. Similarly, because the sum m of the number of times of reference made to the macroblock of packet 504 is 1, the QoS control information is generated by setting 5 as the maximum number of retransmission times.

As described above, normally, the larger the sum m of the number of times of reference made to the macroblock included in a packet is, the more importance (a higher degree of importance) is attached to the packet, and the maximum number of retransmission times is also set higher for the wireless section in packet transmission.

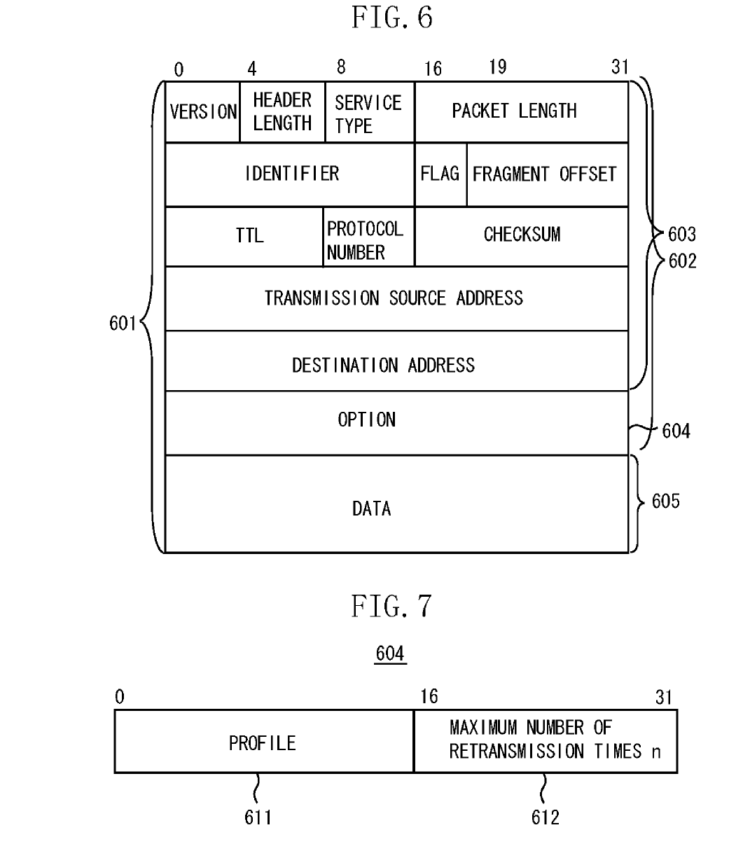

FIG. 6 illustrates a structure of an IP packet generated by the packet generation unit 203 of the data transmission apparatus 101 according to the first exemplary embodiment.

As illustrated in FIG. 6, an IP packet 601 includes main two sections, a header section 602 and a data section 605 carried by the IP packet. In the first exemplary embodiment, moving image data which is divided into payloads by the packet generation unit 203 is stored in the data section 605.

The header section 602 includes a fixed length section 603 (leading 20 bytes) and an optional section 604. In the optional section 604, variable-length extension information can be set in 4-byte units (32-bit) up to a maximum of 40 bytes. The optional section 604 is an area to record information used to implement various additional functions required for IP-packet transmission. In the first exemplary embodiment, the QoS control information is recorded in the optional section 604.

FIG. 7 illustrates a structural example of the optional section 604 in FIG. 6. A field 611 with a width of 16-bit stores information referred to as a profile used to identify information included in the optional section 604. In the first exemplary embodiment, “0x0001” which indicates that a maximum number of retransmission times of a packet is included as the QoS control information, is always recorded in the field 611. A field 612 with a width of 16-bit stores the QoS control information. In the first exemplary embodiment, the maximum number of retransmission times of a packet is stored in the field 612.

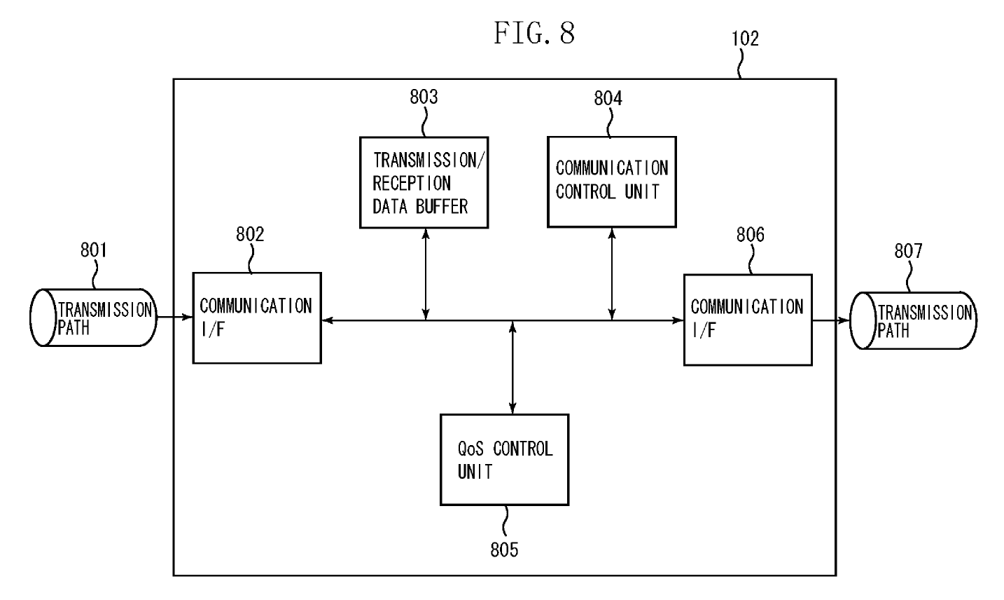

FIG. 8 is a block diagram illustrating an example of functional configuration of the first data relaying apparatus 102 according to the first exemplary embodiment.

As illustrated in FIG. 8, the first data relaying apparatus 102 includes communication interfaces 802 and 806, a transmission/reception data buffer 803, a communication control unit 804, and a QoS control unit 805.

In FIG. 8, various kinds of networks are representative of transmission paths 801 and 802 via which transmission and reception of packets of moving image data is performed in the first exemplary embodiment. The first data relaying apparatus 102 receives a packet of moving image data transmitted from the data transmission apparatus 101 via the transmission path 801, and transfers the received packet to the second data relaying apparatus 103 via the transmission path 807. As described above, data is transmitted by wireless transmission between the first data relaying apparatus 102 and the second data relaying apparatus 103.

The communication interface 802 transmits and receives data to and from the data transmission apparatus 101 via the transmission path 801. The communication interface 806 transmits and receives data to and from the second data relaying apparatus 102 via the transmission path 807. The transmission/reception buffer 803 stores data which is transmitted to or received from a storage unit (not shown).

The communication control unit 804 controls data transmission and reception. The communication control unit 804 controls the communication path and a protocol in data transmission, for example. The QoS control unit 805 controls QoS processing in packet transmission. When the control information for QoS control (communication service quality control) (hereafter referred to as QoS control information) is added to a packet, the QoS control unit 805 analyzes the QoS control information and controls the QoS processing based on a result of the analysis. Functions as a receiving unit, an analysis unit, and a communication control unit are implemented by the communication control unit 804 and the QoS control unit 805.

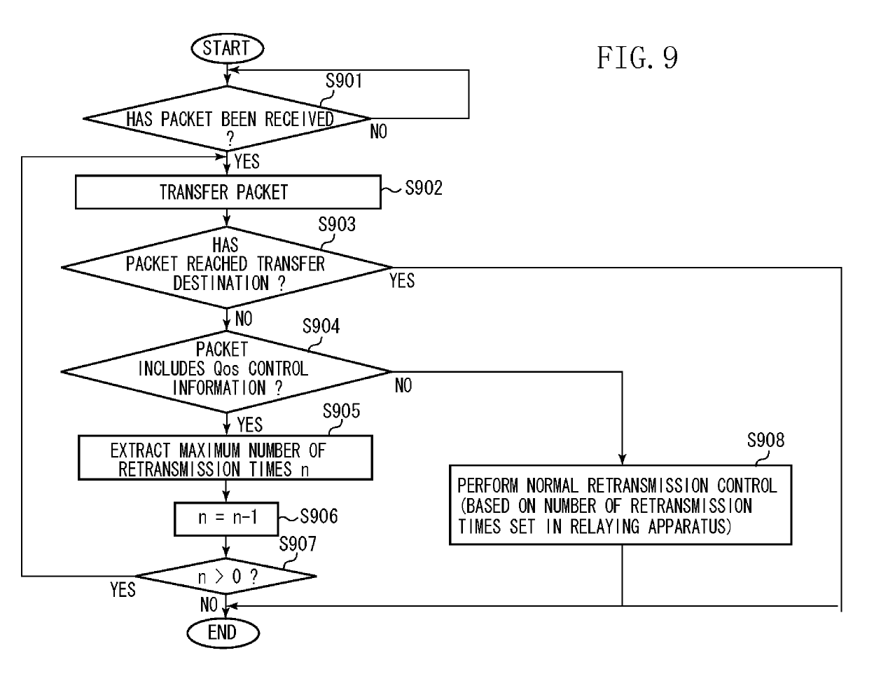

FIG. 9 is a flowchart illustrating an example of a procedure for packet transfer processing in the first data relaying apparatus 102 in the first exemplary embodiment.

In step S901, the first data relaying apparatus 102 causes the communication control unit 804 to determine whether a packet has been received from the data transmission apparatus 101. If it is determined that a packet has not been received (NO in step S901), the communication control apparatus 102 waits until a packet is received. On the other hand, as a result of analysis in step S901, if it is determined that a packet has been received (YES in step S901), processing proceeds to step S902. In step S902, the communication control unit 804 transfers the packet which is received from the data transmission apparatus 101 and stored in the transmission/reception data buffer 803 to a predetermined destination.

Then in step S903, the communication control unit 804 determines whether the packet has reached the second data relaying apparatus 103 as the transfer destination of the packet. The determination can be made whether an Ack indicating that the packet has normally reached is returned from the second data relaying apparatus 103 within a predetermined time. If the Ack is returned, the communication control unit 804 determines that the packet has reached the second data relaying apparatus 103, or if the Ack is not returned within the predetermined time, the communication control unit 804 determines that the packet has not reached the second data relaying apparatus 103.

As a result of determination in step S903, if it is determined that the packet has reached the second data relaying apparatus 103 (YES in step S903), the packet transfer processing is terminated.

On the other hand, as a result of determination in step S903, if it is determined that the packet has not reached the second data relaying apparatus 103 (NO in step S903), processing proceeds to step S904. In step S904, the QoS control unit 805 determines whether the packet includes the QoS control information. In other words, the QoS control unit 805 determines whether the maximum number of retransmission times is recorded as the QoS control information in the packet.

It can be determined in step S904 whether the maximum number of retransmission times is recorded based on information in the optional section 604 in the header section 602 of the packet recorded by the data transmission apparatus 101. In other words, when “0x0001” is recorded in the field 611 illustrated in FIG. 7, it can be determined that the maximum number of retransmission times of the packet is set in the field 612, or when data other than “0x0001” is recorded in the field 611, it can be determined that the maximum number of retransmission times of the packet is not set in the field 612.

As a result of determination in step S904, if it is determined that the maximum number of retransmission times is recorded in the packet (YES in step S904), then in step S905, the QoS control unit 805 extracts the maximum number of retransmission times n from the packet. Then in step S906, 1 is subtracted from the number n.

In step S907, the QoS control unit 805 determines whether the number n is larger than 0. If it is determined that the number n is equal to or smaller than 0 (NO in step S907), the retransmission times of the packet has reached the maximum number of retransmission times set in the packet. Therefore, the packet transfer processing is terminated without performing retransmission processing. On the other hand, if it is determined that the number n is larger than 0 (YES in step S907), the process returns to step S902 to retransmit the packet.

As a result of determination in step S904, if it is determined that the maximum number of retransmission times is not recorded in the packet (NO in step S904), processing proceeds to step S908. In step S908, the QoS control unit 805 performs normal retransmission control on the packet, and the packet transfer processing is terminated. The normal retransmission control is retransmission control which is performed based on the maximum number of retransmission times previously set in the first data relaying apparatus 102, for example.

By the above processing, the packet of the moving image data which is transmitted by the data transmission apparatus 101, and transferred from the first data relaying apparatus 102 to the second data relaying apparatus 103 is carefully controlled in terms of a number of retransmission times according to the degree of importance of each packet, and transferred to a predetermined destination.

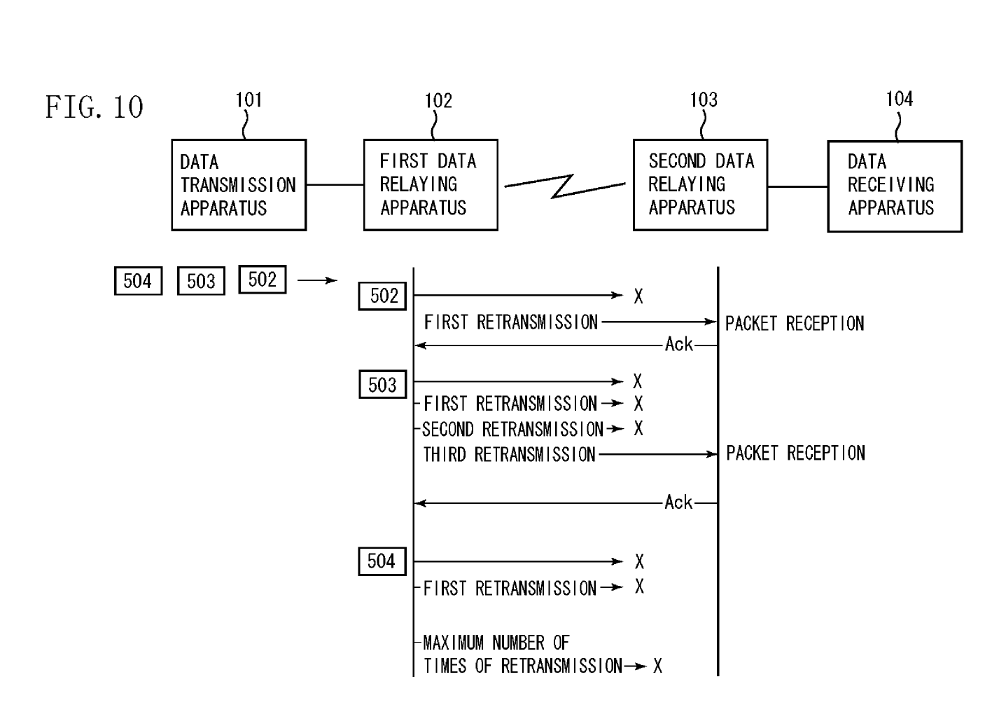

FIG. 10 illustrates an example of a sequence of packet retransmission control between the first and second data relaying apparatuses 102 and 103 in the first exemplary embodiment. In the example in FIG. 10, packets transmitted from the data transmission apparatus 101 are the packets 502 to 504 illustrated in FIG. 5.

The first data relaying apparatus 102 sequentially receives the packets 502 to 504 of the moving image data which include the QoS control information transmitted from the data transmission apparatus 101 and transfers those packets to the second data relaying apparatus 103. During this operation, if the first data relaying apparatus 102 does not receive an Ack from the second data relaying apparatus 103 even after a predetermined time has passed, it is determined that the packet is lost in the wireless section (a section where the packets are transmitted by wireless communication) between the first data relaying apparatus 102 and the second data relaying apparatus 103. Then, the first data relaying apparatus 102 analyzes the QoS control information included in the packet, and, based on a result of analysis, performs QoS control on each packet. In the first exemplary embodiment, a number of retransmission times of a packet which is determined to be lost is controlled according to a maximum number of retransmission times set in each packet.

First, the packet 502 is transferred from the first data relaying apparatus 102. However, an Ack is not returned from the second data relaying apparatus 103 within the predetermined time. Therefore, the first data relaying apparatus 102 retransmits the packet 502 based on the maximum number of retransmission times (6 times) set in the packet 502. The second data relaying apparatus 103, when the packet 502 is received in the first retransmission, immediately returns the Ack to the first data relaying apparatus 102.

Then, the packet 503 is transferred from the first data relaying apparatus 102. However, the Ack is not returned from the second data relaying apparatus 103 within the predetermined time. Therefore, the first data relaying apparatus 102 retransmits the packet 503 based on the maximum number of retransmission times (8 times) set in the packet 503. The second data relaying apparatus 103, when the packet 503 is received in the third retransmission, instantly returns the Ack to the first data relaying apparatus 102.

Finally, the packet 504 is transferred from the first data relaying apparatus 102. Yet, as with the packets 502 and 503, the Ack is not returned from the second data relaying apparatus 103 within the predetermined time. Therefore, the first data relaying apparatus 102 retransmits the packet 504 according to the maximum number of retransmission times (5 times) set in the packet 504. However, since the packet 504 cannot be transferred to the second data relaying apparatus 103 even though retransmission processing is repeated the maximum number of retransmission times, the first data relaying apparatus 102 gives up the packet transfer processing of the packet 504.

As described above, the data transmission apparatus 101 in the first exemplary embodiment transmits a packet by recording thereon a maximum number of retransmission times of packet as QoS control information according to a degree of importance of each packet of moving image data and a transmission quality of a transmission path. When a packet transmitted from the data transmission apparatus 101 is transferred, the first data relaying apparatus 102 controls packet retransmission processing by referring to the maximum number of retransmission times recorded as the QoS control information in the packet.

Thus, in the wireless section where many errors occur (between the data relaying apparatuses 102 and 103), unnecessary packet retransmission can be limited, and optimum control of packet retransmission processing can be performed according to a state of the transmission quality that changes with time and the degree of importance of each packet of moving image data. Therefore, data can be transmitted by meticulously performing the QoS control (communication service quality control) on each packet in the wireless section while maintaining the communication service quality of moving images and effectively using communication bands.

A second exemplary embodiment of the present invention is described below.

In the first exemplary embodiment, packet retransmission control is performed by recording a maximum number of retransmission times as the QoS control information added to a packet. In contrast, in the second exemplary embodiment, packet retransmission control is performed by recording allowable delay time as QoS control information added to a packet. The whole communication system configuration, the data transmission apparatus, and the first data relaying apparatus in the second exemplary embodiment are the same as those in the first exemplary embodiment. Therefore, their descriptions are not repeated.

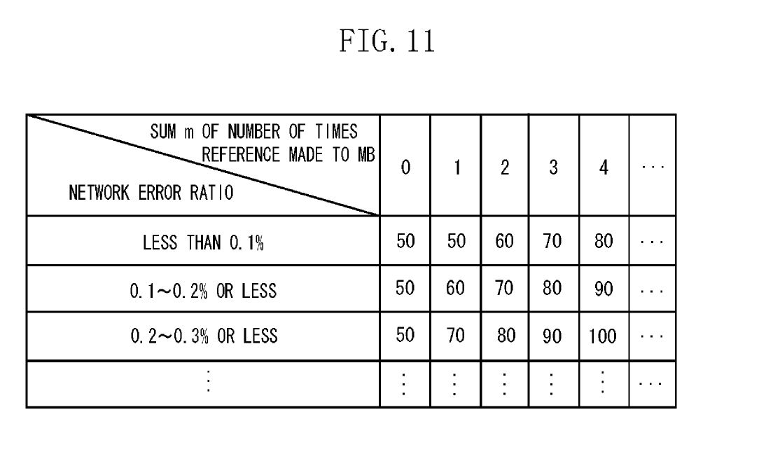

FIG. 11 is an example of a table for selecting allowable delay time. The table for selecting allowable delay time is provided in the QoS control information generation unit 204 in the data transmission apparatus 101. In the second exemplary embodiment, allowable delay time as the QoS control information is recorded on the millisecond time scale.

Items of the table for selecting allowable delay time illustrated in FIG. 11 include the sum of the number of times of references made to the macroblock and the network error ratio, like the table for selecting a maximum number of retransmission times illustrated in FIG. 4. More specifically, the table for selecting allowable delay time illustrated in FIG. 11 stores the sum of the number of times of references made to the macroblock which indicates the degree of importance of each packet of moving image data and the network error ratio which indicates the transmission quality of the network by associating with the allowable delay time as the QoS control information. By using the table for selecting allowable delay time, a threshold value of the allowable delay time can be determined based on the values of the items.

Generally, a packet having a large sum m of the number of times of references made to the macroblock included in the packet has a high degree of importance. Under the condition that the transmission quality of the network is the same, the allowable delay time is set longer as the packet has the larger sum m of the number of times of references made to the macroblock. Conversely, a packet with a small sum m of the number of times of reference made to the macroblock has a low degree of importance. Therefore under the condition that the transmission quality of the network is the same, the allowable delay time is set shorter as the packet has the smaller sum m of the number of times of references made to the macroblock.

Even when the sum m of the number of times of references made to the macroblock is the same, that is, when the degree of importance of the packet is the same, the allowable delay time changes according to the transmission quality of the network, and normally, the maximum number of retransmission times is set larger as the error ratio of the network becomes larger. For an application which requires real-time performance, the allowable delay time is set shorter on the whole table for selecting allowable delay time.

Arbitrary values can be used for increments in the allowable delay time for an increase in the sum m of the number of times of references made to the macroblock and for the network error ratio. For those values, optimum values may be determined based on experience considering an overall balance.

The QoS control information generation unit 204 determines the allowable delay time for each packet in a section (wireless section of the network) where packets are transferred by wireless communication based on the sum m of the number of times of references made to the macroblock and the network error ratio using the table for selecting allowable delay time. The packet generation unit 203 records generated payload data and the allowable delay time of each packet determined and input by the QoS control information generation unit 204 on the packet, and generates the packet to be transmitted.

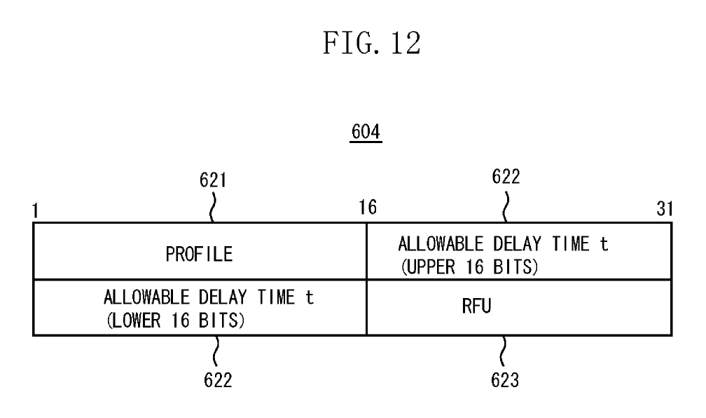

FIG. 12 illustrates a structural example of an optional section 604 of an IP packet in the second exemplary embodiment. The structure of the IP packet in the second exemplary embodiment is the same as that of the IP packet in the first exemplary embodiment illustrated in FIG. 6, except for the optional section 604.

A field 621 with a width of 16-bit stores information referred to as a profile which is used to identify information included in the optional section 604. In the second exemplary embodiment, “0x0002” which indicates that an allowable delay time of a packet is included as the QoS control information is always recorded in the field 621. A field 622 with a width of 32-bit stores the QoS control information. In the second exemplary embodiment, the allowable delay time of a packet required for retransmission, is stored by milli-seconds in the field 622. A field 623 is a Reserved for Future Use (RFU) field which is a 16-bit empty area reserved for extension in the future.

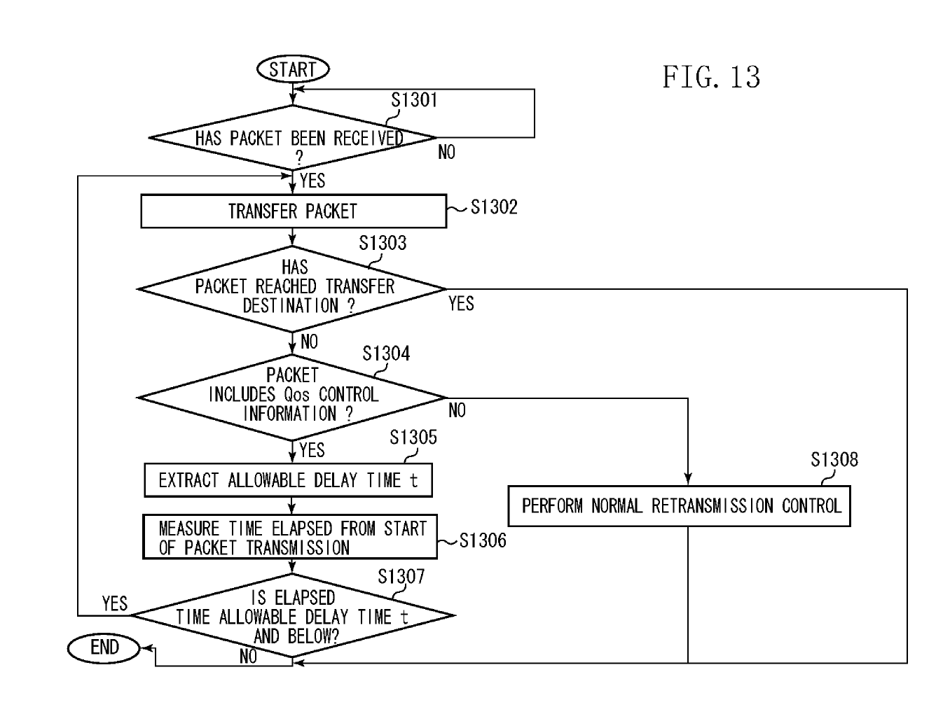

FIG. 13 is a flowchart illustrating an example of a procedure for the packet transfer processing in the first data relaying apparatus 102 in the second exemplary embodiment.

In step S1301, the first data relaying apparatus 102 causes the communication control unit 804 to determine whether a packet has been received from the data transmission apparatus 101. If it is determined that a packet has not been received (NO in step S1301), the communication control apparatus 102 waits until a packet is received. On the other hand, if it is determined that a packet has been received (YES in step S1301), processing proceeds to step S1302. In step S1302, the communication control unit 804 transfers the packet which is received from the data transmission apparatus 101 and stored in the transmission/reception data buffer 803 to a predetermined destination.

Then in step S1303, the communication control unit 804 determines whether the packet has reached the second data relaying apparatus 103 as the transfer destination of the packet. For example, if an Ack which indicates that the packet has normally reached is returned, the communication control unit 804 determines that the packet has reached the second data relaying apparatus 103. If the Ack is not returned within the predetermined time, the communication control unit 804 determines that the packet has not reached the second data relaying apparatus 103. As a result of determination in step S1303, if it is determined that the packet has reached the second data relaying apparatus 103 (YES in step S1303), the packet transfer processing is terminated.

On the other hand, as a result of determination in step S1303, if it is determined that the packet has not reached the second data relaying apparatus 103 (NO in step S1303), processing proceeds to step S1304. In step S1304, the QoS control unit 805 determines whether the allowable delay time as the QoS control information has been recorded in the packet. The determination in step S1304 can be made based on information recorded in the optional section 604 in the header section 602 of the packet recorded by the data transmission apparatus 101. In other words, when “0x0002” is recorded in the field 621 illustrated in FIG. 12, it can be determined that the allowable delay time of the packet is set in the field 622, or when data other than “0x0002” is recorded in the field 611, it can be determined that the allowable delay time of the packet is not set in the field 622.

As a result of determination in step S1304, if it is determined that the allowable delay time is recorded in the packet (YES in step S1304), then in step S1305, the QoS control unit 805 extracts allowable delay time t from the packet. Then in step S1306, the QoS control unit 805 measures time elapsed from start of packet transfer. The elapsed time from the start of packet transfer is calculated by a clock that provides standard time available on the Internet or a clock in the first data relaying apparatus 102.

In step S1307, the QoS control unit 805 determines whether the elapsed time from the start of packet transfer is equal to or less than the allowable delay time t set in the packet. If it is determined that the elapsed time from the start of packet transfer is longer than the allowable delay time t, that is, when the allowable delay time has passed (NO in step S1307), because time required for retransmission has reached the allowable delay time set in the packet, the packet transfer processing is terminated without performing retransmission processing.

On the other hand, if it is determined that the elapsed time from the start of packet transfer is equal to or less than the allowable delay time t (YES in step S1307), the process returns to step S1302 to retransmit the packet. Thus, for a period from the start of packet transfer till the end of the allowable delay time, retransmission of the packet is repeated.

In contrast, as a result of determination in step S1304, if it is determined that the allowable delay time is not recorded in the packet (NO in step S1304), processing proceeds to step S1308. In step S1308, the QoS control unit 805 performs normal retransmission control on the packet, and the packet transfer processing is terminated. The normal retransmission control is, for example, retransmission control based on the maximum number of retransmission times previously set in the first data relaying apparatus 102.

By the above processing, the packet of the moving image data which is transmitted by the data transmission apparatus 101 and transferred from the first data relaying apparatus 102 to the second data relaying apparatus 103 is transferred controlling time required for retransmission in a meticulous manner according to the degree of importance of each packet.

The data transmission apparatus 101 in the second exemplary embodiment records, on each packet, the allowable delay time required to retransmit a packet as QoS control information based on the degree of importance of each packet of the moving image data and the transmission quality of the transmission path, and then transmits the packet. When a packet received from the data transmission apparatus 101 is transferred, the first data relaying apparatus 102 in the second exemplary embodiment controls packet retransmission processing by referring to the allowable delay time recorded as the QoS control information in each packet.

Thus, in the wireless section where many errors occur (between the data relaying apparatuses 102 and 103), unnecessary packet retransmission can be limited, and optimum control of packet retransmission processing can be performed according to a state of the transmission quality that changes with time and the degree of importance of each packet of moving image data. Therefore, data can be transmitted by meticulously performing the QoS control (communication service quality control) on each packet in the wireless section while maintaining the communication service quality of moving images and effectively using the communication bands.

A third exemplary embodiment of the present invention is described below.

In the first exemplary embodiment, a maximum number of retransmission times is recorded as the QoS control information added to the packet and packet retransmission control is performed. In contrast, in the third exemplary embodiment, a transmission priority is recorded as the QoS control information added to a packet, and packet transmission control is performed. The whole communication system configuration, and the data transmission apparatus in the third exemplary embodiment are the same as those in the first exemplary embodiment. Therefore, their descriptions are not repeated. For the first data relaying apparatus and the second data relaying apparatus, ordinary devices such as routers and switches provided with a priority control function may be employed.

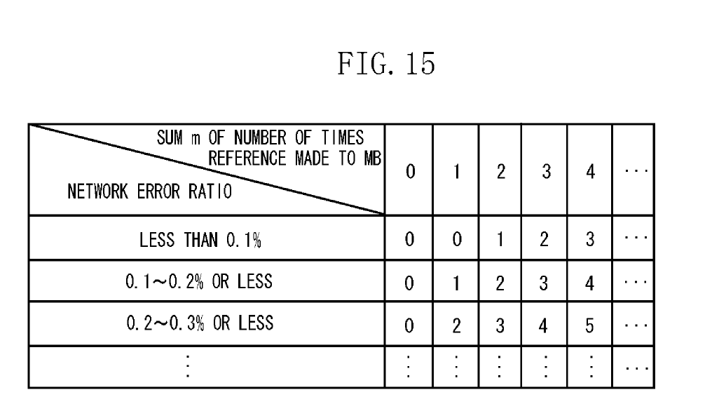

FIG. 15 is an example of a table for selecting a transmission priority. The table for selecting a transmission priority is stored in the QoS control information generation unit 204 in the data transmission apparatus 101. In this third exemplary embodiment, the transmission priority is recorded as the QoS control information.

Items of the table for selecting a transmission priority illustrated in FIG. 15 include the sum of the number of times of references made to the macroblock and the network error ratio as the table for selecting a maximum number of retransmission times illustrated in FIG. 4. More specifically, the table for selecting a transmission priority illustrated in FIG. 15 stores the sum of the number of times of references made to the macroblock which indicates the degree of importance of each packet of moving image data and the network error ratio which indicates the transmission quality of the network by associating with the transmission priority as the QoS control information. By using the table for selecting a transmission priority, a threshold value of the transmission priority can be determined based on the values of the items.

Generally, a packet having a large sum m of the number of times of references made to the macroblock included in the packet has a high degree of importance. Under the condition that the transmission quality of the network is the same, the transmission priority is set higher as the packet has the larger sum m of the number of times of references made to the macroblock. Conversely, a packet with a small sum m of the number of times of references made to the macroblock has a low degree of importance. Therefore under the condition that the transmission quality of the network is the same, the transmission priority is set lower as the packet has the smaller sum m of the number of times of references made to the macroblock.

Even when the sum m of the number of times of references made to the macroblock is the same, that is, when the degree of importance of the packet is the same, the transmission priority changes according to the transmission quality of the network, and normally, the maximum number of retransmission times is set larger as the error ratio of the network becomes larger. For an application which requires real-time performance, the transmission priority is set higher on the whole table for selecting a transmission priority.

Arbitrary values can be used for increments in the transmission priority for an increase in the sum m of the number of times of references made to the macroblock and for the network error ratio. For those values, optimum values may be determined based on experience considering an overall balance according to a priority setting range to be described below.

The QoS control information generation unit 204 determines the transmission priority for each packet in a section (wireless sections of the network) where packets are transferred by wireless communication based on the sum m of the number of times of references made to the macroblock and the network error ratio by using the table for selecting a transmission priority. The packet generation unit 203 records generated payload data and the transmission priority of each packet determined and input by the QoS control information generation unit 204 in the packet, and generates the packet to be transmitted.

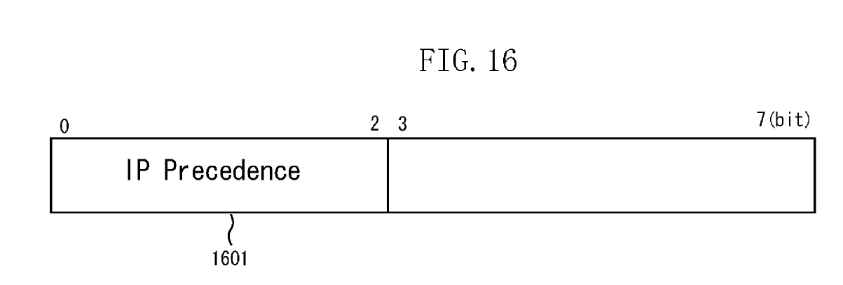

FIG. 16 illustrates a structural example of a type of service (hereafter referred to as TOS) in a fixed section 603 of an IP packet in the third exemplary embodiment. The structure of the IP packet in the third exemplary embodiment is the same as that of the IP packet in the first exemplary embodiment in FIG. 6, except that the optional section 604 is omitted from the IP packet 601.

In the third exemplary embodiment, a transmission priority of a packet is expressly specified in a field in the packet and recorded in a QoS-specified exclusive field which is defined by the TOS. The TOS field is a field at 9th to 16th bits from a head of the IP address. By using a field of IP Precedence 1601 in the leading three bits of the TOS field, an order of transfer priority is specified in eight stages from 0 to 7. The larger the number in the IP Precedence 1601, the more important the packet is considered to be. However, normally, the maximum number that can be set is 5, and it is recommended not to use 6 and 7.

In the IP Precedence 1601, the priority order can be defined in only eight stages. Therefore, more stages can be specified for the priority order by using a field referred to as a differentiated services code point (DSCP) that uses the same TOS field. The DSCP field is located in the leading 6 bits of the TOS field. By specifying 64 stages of transfer priority using the DSCP, the priority order can be set more meticulously than in the IP Precedence 1601.

As described above, the packet of the moving image data transmitted from the data transmission apparatus 101 is transferred while transmission priority is controlled meticulously based on the degree of importance of each packet in the first data relaying apparatus 102 and the second data relaying apparatus 103 along the communication path.

The data transmission apparatus 101 in the third exemplary embodiment records in the packet a transmission priority of the packet as the QoS control information based on the degree of importance of each packet of the moving image data and the transmission quality of the transmission path, and then transmits the packet. When a packet transmitted from the data transmission apparatus 101 is transferred, the first data relaying apparatus 102 and the second data relaying apparatus 103 in the third exemplary embodiment refers to the order of the transmission priority recorded as the QoS control information in the packet, and performs packet transfer processing according to the order of priority.

Therefore, even when network traffic is heavy, control of packet transmission processing in an optimum way can be performed according to the degree of importance of each packet of the moving image data and a state of the transmission quality that changes with time. Therefore, data can be transmitted by meticulously performing the QoS control on each packet of the moving image data while maintaining the communication service quality of moving images and effectively utilizing the communication bands.

In the above exemplary embodiments, the degree of importance of each packet is determined based on the number of times of references made to the macroblock included in the payload of the packet of the moving image data. However, the degree of importance of packet can be determined based on a frame type of the moving image data. For example, it may be arranged that an intra-frame coded frame (I frame in MPEG system) is determined to have a high degree of importance and an inter-frame prediction coded frame (P frame and B frame in MPEG system) is determined to have a low degree of importance.

In the above exemplary embodiments, the first data relaying apparatus 102 determines whether a packet has reached the second data relaying apparatus 103 as the packet transfer destination by checking whether an Ack from the second data relaying apparatus 103 is received or not, and then performs the packet retransmission processing. However, the exemplary embodiments of the present invention is not limited to this operation, and it may be arranged such that the second data relaying apparatus 103 at a receiving side sends a retransmit request to the first data relaying apparatus 102, and upon receiving the retransmit request, the first data relaying apparatus 102 performs the packet retransmission processing.

In the above exemplary embodiments, the data transmission apparatus 101 includes the function to perform coding processing of moving image data, but the moving image coding unit 202 may be provided separately from the data transmission apparatus 101.

In the above exemplary embodiments, MPEG-4 system is used for the coding system of moving image data, and Internet Protocol (IP) is used as the network protocol to communicate coded moving image data. However, the coding system for moving image data is not limited to MPEG-4 system, but similar coding systems that use prediction coding, such as MPEG-2 and H.264 may be used. Moreover, for the network protocol, it is not limited to IP, but any other network protocol may be used.

The above-described exemplary embodiments can be implemented by software installed in a computer (a central processing unit (CPU), and a micro processing unit (MPU), for example, in a system or an apparatus. Therefore, the present invention is implemented by computer programs themselves which are supplied and installed in the computers to implement the functions of those exemplary embodiments by the computers. In other words, the computer programs to implement the functions of those exemplary embodiments constitutes the present invention. In this case, so long as programs include the functions, programs may be in any form, such as an object code, programs executable by an interpreter, or script data supplied to an operation system (OS).

The computer program to cause the computer to implement the functions of the exemplary embodiments may utilize the functions of the OS running on the computer to implement the functions of the embodiments. Moreover, at least part of the computer program which constitutes the present invention may be supplied as firmware, such as an extension board mounted in the computer, and the functions of the embodiments can be implemented by using the CPU installed in the extension board.

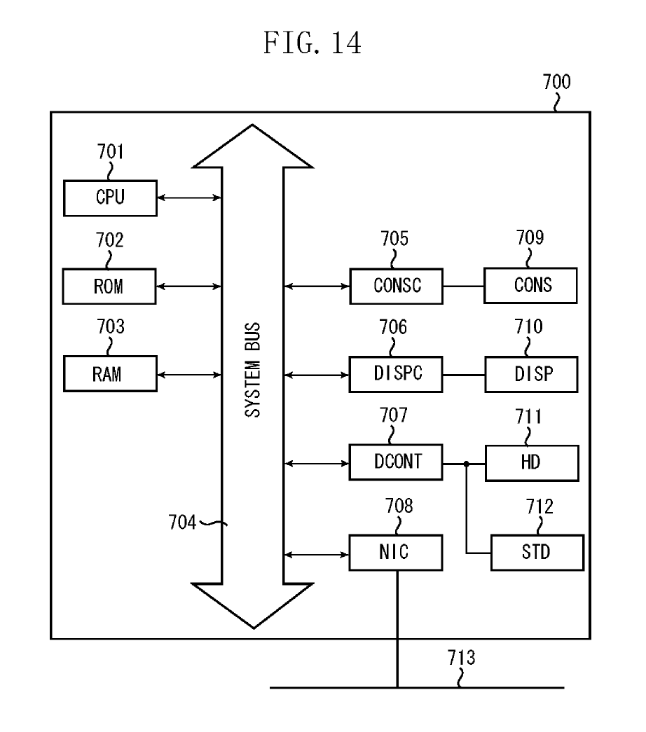

For example, the data transmission apparatus 101 and the first data relaying apparatus 102 which are communication apparatuses described in the first to the third embodiments, each includes a computer function 700 as illustrated in FIG. 14, and a CPU 701 executes the operations in the first to the third embodiments.

As illustrated in FIG. 14, the computer function 700 includes the CPU 701, a read-only memory (ROM) 702, and a random access memory (RAM) 703. The computer function 700 further includes a controller (CONSC) 705 of an operation console (CONS) 709, and a display controller (DISPC) 706 of a display (DISP) 710 as a cathode-ray tube (CRT) or a liquid crystal display (LCD) In addition, the computer function 700 includes a controller (DCONT) 707 for a hard disk (HD) 711 and a storage device 712, such as a flexible disk, and a network interface card (NIC) 708. Those functional units 701, 702, 703, 705, 706, 707, and 708 are connected via a system bus 704 in a mutually communicable manner.

The CPU 701 executes software stored in the ROM 702 or the HD 711, or executes software supplied from the STD 712 to comprehensively control those units connected to the system bus 704. In other words, the CPU 701 controls to implement the operations in the first to the third exemplary embodiments by executing processing programs to perform the above described operations which are read from the ROM 702, the HD 711, or STD 712. The RAM 703 serves as a main memory or a work area of the CPU 701.

The CONSC 705 controls command input from the CONS 709. The DISPC 706 controls display on the DISP 710. The DCONT 707 controls access to the HD 711 and the STD 712 which store the boot program, various applications, user files, network management programs, and the above-described processing programs in the first to the third embodiments. The NIC 708 performs bidirectional data transfer with the other equipment on the network.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2008-186243 filed Jul. 17, 2008, which is hereby incorporated by reference herein in its entirety.

What is claimed is:

1. A communication apparatus configured to transmit moving image data to a receiving apparatus via a network, the communication apparatus comprising:
a coding unit configured to code the moving image data;
a control information generation unit configured to determine a degree of importance of each packet of the moving image data coded by the coding unit and transmission quality of the network, and generate, for each packet, control information to control communication service quality according to the determined degree of importance and transmission quality;
a packet generation unit configured to generate a packet based on the moving image data coded by the coding unit and the control information generated by the control information generation unit; and
a communication control unit configured to transmit the packet generated by the packet generation unit.

2. The communication apparatus according to claim 1, wherein when a request to retransmit the packet is sent from a receiving side connected via the network, the communication control unit retransmits the packet based on the control information generated by the control information generation unit.

3. The communication apparatus according to claim 1, wherein the control information generation unit includes a table that stores the degree of importance of the moving image data and the transmission quality of the network which are associated with the control information, and generates the control information based on the table.

4. The communication apparatus according to claim 1, wherein the control information generation unit determines the degree of importance of the moving image data based on a frame type of the moving image data.

5. The communication apparatus according to claim 1, wherein the control information generation unit determines the degree of importance of the moving image data based on a number of times that a macroblock included in a packet of the moving image data has been referred to.

6. The communication apparatus according to claim 1, wherein the packet generation unit records the control information generated by the control information generation unit in a header portion of the packet.

7. The communication apparatus according to claim 1, wherein the control information includes a maximum number of retransmission times, allowable delay time, or transmission priority of the packet.

8. The communication apparatus according to claim 1, wherein the network includes a section where the packet is transmitted using wireless communication and the control information generation unit generates control information to control communication service quality in the section.

9. A communication apparatus configured to receive a packet of moving image data transmitted from a transmission apparatus and transfer the received packet to another communication apparatus connected via a network, the communication apparatus comprising:
a receiving unit configured to receive the packet transmitted from the transmission apparatus;
an analysis unit configured to analyze control information for communication service quality control which is included in each packet received by the receiving unit; and
a communication control unit configured to perform the communication service quality control on each packet according to a result of analysis by the analysis unit, and transfer the packet,
wherein the control information is associated with a degree of importance of each packet of the moving image data and transmission quality of the network.

10. The communication apparatus according to claim 9, wherein when a request to retransmit the packet is sent from a receiving side connected via the network, when the communication control unit, retransmits the packet based on the control information.

11. The communication apparatus according to claim 9, wherein the network includes a section where the packet is transmitted using wireless communication and the control information is information for controlling communication service quality in the section.

12. A communication method of transmitting moving image data to a receiving apparatus via a network, the method comprising:
coding the moving image data;
determining a degree of importance of each packet of the coded moving image data and transmission quality of the network and generating, for each packet, control information to control communication service quality according to the determined degree of importance and transmission quality;
generating a packet based on the coded moving image data and the generated control information; and
transmitting the generated packet.

13. A communication method of receiving a packet of moving image data transmitted from a transmission apparatus and transferring the received packet to another communication apparatus connected via a network, the method comprising:
receiving the packet transmitted from the transmission apparatus;
analyzing control information for communication service quality control which is included in each of the received packet; and
performing the communication service quality control on each packet according to a result of the analysis, and transferring the packet,
wherein the control information is associated with the degree of importance of each packet of the moving image data and transmission quality of the network.

14. A computer-readable recording medium for storing a program to cause a computer to execute a process to transmit moving image data to a receiving apparatus via a network, wherein the program comprising:
coding the moving image data;
determining a degree of importance of each packet of the coded moving image data and transmission quality of the network and generating, for each packet, control information to control communication service quality according to the determined degree of importance and transmission quality;
generating a packet based on the coded moving image data and the generated control information; and
transmitting the generated packet.

15. A computer-readable recording medium for storing a program to cause a computer to execute a process which receives a packet of moving image data transmitted from a transmission apparatus and transfers the received packet to another communication apparatus connected via a network, wherein the program comprising:
receiving the packet transmitted from the transmission apparatus;
analyzing control information for communication service quality control which is included in each of the received packet; and
performing the communication service quality control on each packet according to a result of the analysis and causing the computer to transfer the packet,
wherein the control information is associated with the degree of importance of each packet of the moving image data and transmission quality of the network.
